(19) United States
(12) Patent Application Publication
(10) Pub. No.: US 2025/0139117 A1
(43) Pub. Date: May 1, 2025

(54) NETWORK MANAGEMENT SYSTEM CLUSTERS HAVING FEDERATED QUERY PROCESSING

(71) Applicant: Hewlett Packard Enterprise Development LP, Spring, TX (US)

(72) Inventors: Gopal Gupta, Bangalore (IN); Satishwar Chandrashekar, Bangalore (IN); Amreesh Agrawal, Bangalore (IN)

(21) Appl. No.: 18/590,348

(22) Filed: Feb. 28, 2024

(30) Foreign Application Priority Data
Oct. 27, 2023 (IN) 202341073447

(51) Int. Cl. G06F 16/25; G06F 16/2455; G06F 16/2458; H04L 41/0893

(52) U.S. Cl. CPC G06F 16/256; G06F 16/24552; G06F 16/24556; G06F 16/2477; H04L 41/0893

(57) ABSTRACT

A process includes, responsive to a migration of a network device deployment from a first network management system cluster to a second network management system cluster, retaining first data in the first network management system cluster for a retention period. The data represents information about the network device deployment. The process includes receiving, by a federation layer engine of the second network management system cluster, a given query directed to information associated with the network device deployment. The process includes determining, by the federation layer engine, whether a query time that is associated with the given query is within the retention period and processing, by the federation layer engine, the given query responsive to the determination of whether the query time is within the retention period.

### BACKGROUND

An enterprise may use a cloud-based network management system to collect, log, visualize and analyze network telemetry metrics. The analyses of network telemetry metrics may be beneficial for a number of purposes, such as identifying network configuration problems, identifying network performance issues, detecting network device failures, recognizing security vulnerabilities and detecting security attacks.

### BRIEF DESCRIPTION OF THE DRAWINGS

FIG. 1 is a block diagram of a computer network having network management system (NMS) clusters having a federated query processing architecture according to an example implementation.

FIG. 2 is a flow diagram depicting a process to migrate a network device deployment from a first NMS cluster to a second NMS cluster according to an example implementation.

FIG. 3 is a block diagram of a federated query processing architecture according to an example implementation.

FIG. 4 is a timeline illustrating the routing of queries using a federated query processing architecture according to an example implementation.

FIG. 5 is a flow diagram depicting the processing of a query received in a target NMS cluster having a network device deployment that was migrated from a migrated NMS cluster according to an example implementation.

FIG. 6 is a flow diagram depicting a process to migrate a network device deployment from a first network management system cluster to a second network management system cluster according to an example implementation.

FIG. 7 is an illustration of machine-readable instructions that, when executed by a machine associated with a target network management system cluster, cause the machine to process a query based on a query time and a data retention period according to an example implementation.

FIG. 8 is a block diagram of a system associated with a first network management system cluster having a federation layer engine to selectively direct a query to either a first query processing layer of the first network management system cluster or a second query processing layer of a second network management system cluster based on the determination of whether a data retention period associated with a network device deployment migration is pending.

### DETAILED DESCRIPTION

A network management system (NMS) cluster may include central NMS components (e.g., cloud-based components) that manage network devices (also referred to as “managed network devices” herein) of a particular network device deployment. In an example, a network device deployment may include a collection of network devices that are associated with a particular geographical location. For example, a particular NMS cluster may include a network device deployment, which includes network devices that are located in one or multiple branch networks that are at the same campus or within the same country state. The central NMS components may include a central server. The managed network devices may generate and send messages (called “network telemetry messages” herein) to the central server. In general, the network telemetry messages may provide information about network telemetry metrics from which an insight to a state of a network, a network device or a client device connected network device(s) may be directly or indirectly determined. In an example, the network device deployment may be associated with a particular customer identification (ID).

An NMS cluster may store information about the network device deployment. In an example, the NMS cluster information may include network artifacts (e.g., network device certificates), acquired network telemetry metrics, network device configuration files and network device configuration settings. The customer of an NMS cluster may submit queries directed to retrieving specific NMS cluster information.

Due to a network device deployment being in a different geographical location than the geographical location of the NMS central components, it may be beneficial to migrate the network devices to a different NMS cluster. For example, a network device deployment may be located in Japan, and the corresponding central NMS components may be located in the United States. Migrating the network device deployment to an NMS cluster that has central NMS components that are located in the same or closer time zone may be beneficial for such purposes as better matching the customer's system up times with maintenance windows. In another example, a customer may migrate a particular network deployment to an NMS cluster that contains the customer's other network devices so that the central NMS components may present, to the customer, a single view of multiple the customer's network devices.

One way to migrate a network device deployment from a first NMS cluster to a second NMS cluster is to move, or migrate, all of the NMS cluster information data from the first NMS cluster to the second NMS cluster. Such an approach, however, may be expensive from both time and cost perspectives. Moreover, such an approach may encounter challenges due to jurisdictional privacy regulations that restrict the movement of data that relates to identified or identifiable natural persons.

In accordance with example implementations, when a network device deployment is migrated from a first NMS cluster to a second NMS cluster, a minimal amount of data (e.g., data migration constrained to non-transitory network artifact data, such as device certificates) is migrated, with most of the NMS cluster information data being retained in the first NMS cluster for a data retention period. In an example, the data retention period may begin at the migration date and end a certain number of calendar days (e.g., 30 days, 60 days or another number of days that is specified by a service level agreement (SLA)) from the migration date. A user (e.g., a system administrator) that is affiliated with the NMS cluster customer may, after the migration date, submit queries to the second NMS cluster to access and/or modify NMS cluster information. The first and second NMS clusters, in accordance with example implementations, have a federated query processing architecture to intelligently direct such queries to query processing layers of one or both NMS clusters.

The federated query processing architecture provides a query processing abstraction that makes the migration of the network device deployment appear to be seamless from the perspective of the customer. The federated query processing architecture handles the routing of a query based on whether the corresponding query time (e.g., the time the query was generated, or the time the query is received by the NMS cluster) is within the data retention period. In accordance with example implementations, if the query time is within the data retention period (i.e., the data retention period is “pending”), then the federated query processing architecture first directs the query to the query processing layer of the first NMS cluster (the migrated NMS cluster), and if the first NMS cluster does not provide some or all of the data to satisfy the query, then the federated query processing architecture directs the query processing to the query processing layer of the second NMS cluster. Moreover, in accordance with example implementations, if the query time is after the end of the data retention period, then the federated query processing architecture directs the query solely to the query processing layer of the second NMS cluster.

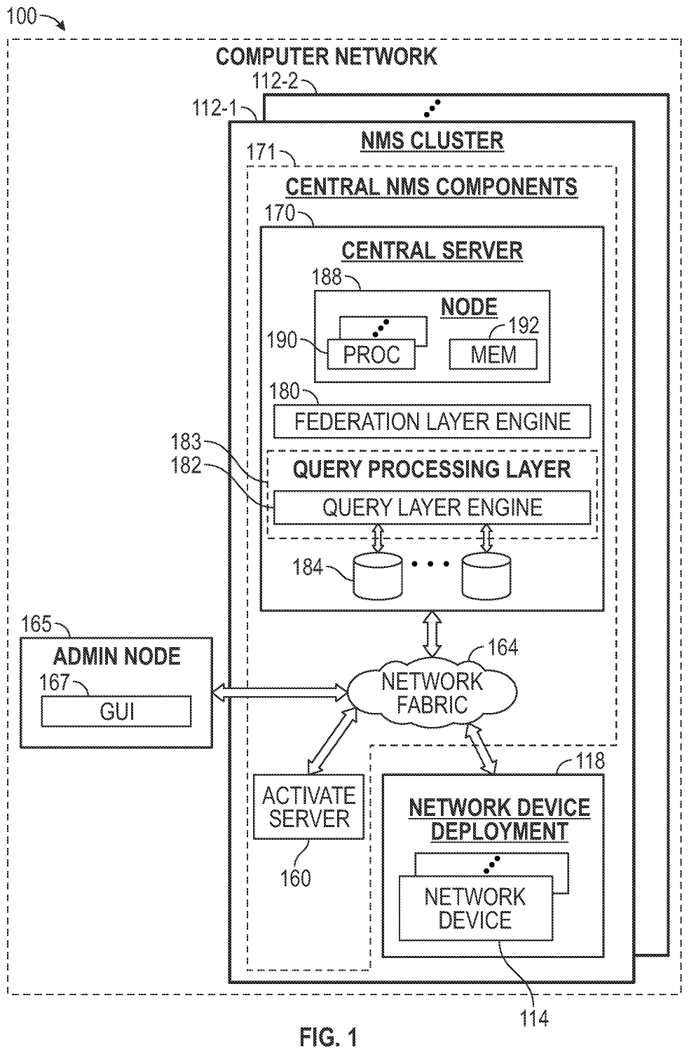

Referring to FIG. 1, as a more specific example, in accordance with some implementations, a computer network 100 includes NMS clusters 112-1 and 112-2. FIG. 1 depicts specific components of the NMS cluster 112-1, with it being understood that the NMS cluster 112-2 may have similar components. References to the “NMS cluster 112” herein pertain to either NMS cluster 112-1 or 112-2.

As depicted in FIG. 1, in accordance with some implementations, the NMS cluster 112 may include central NMS resources, or components 171, such as a central server 170 and an activate server 160. Moreover, the NMS cluster 112 may include a network device deployment 118. The network device deployment 118 includes network devices 114.

In the context that is used herein, an “NMS cluster” refers to a collection of one or multiple network device deployments and one or multiple components that provide one or multiple services (also referred to as “management services” or “NMS services”) to manage the network device deployment(s). In an example, an NMS cluster may include a single central server (a management component) that provides NMS service(s) to manage one or multiple network device deployments. In another example, an NMS cluster may include a high availability (HA) group of central servers, and a particular active central server of the HA group may provide NMS service(s) for one or multiple network device deployments of the NMS cluster. In an example, an NMS cluster may include a management component other than a central server, such as an activate server. A “network device deployment,” in the context that is used herein, refers to a collection of one or multiple network devices that are affiliated with a particular customer of the NMS service(s).

One or multiple NMS clusters 112 may be associated with a particular customer. In an example, the network device deployment 118 may correspond to a local branch network (e.g., a local area network (LAN)), such as a network that corresponds to a particular building, group of buildings, campus, edge computer system or datacenter. In another example, the network device deployment 118 may include multiple local branch networks. The network device deployment 118 may be associated with a particular geographical location, such as a campus site or city, and in accordance with some implementation the network device deployment 118 may have a larger geographical span and be associated with a particular state, country or geographical region encompassing multiple countries. In accordance with some implementations, the central NMS components 171 may be cloud-based resources that may be located in one or multiple datacenters.

In accordance with example implementations, the network devices 114 and central NMS components 171 of an NMS cluster 112 may communicate over network fabric 164. In accordance with example implementations, the network fabric 164 may be associated with one or multiple types of communication networks, such as (as examples) Fibre Channel networks, Compute Express Link (CXL) fabric, dedicated management networks, local area networks (LANs), WANs, global networks (e.g., the Internet), wireless networks, or any combination thereof.

In accordance with example implementations, the central server 170 may provide one or multiple NMS services. The NMS services may include any of a number of different services for visualizing, analyzing, logging, collecting, configuring querying and/or monitoring information (e.g., network telemetry metrics) that is associated with the network device deployment 118. Data corresponding to this information may be stored in one or multiple databases 184 of the NMS cluster 112. The central server 170 may serve data to a dashboard, such as a graphical user interface (GUI) 167, that allows a user (e.g., a system administrator) of the associated customer monitor network events. For example, the GUI 167 may display graphical data that represents telemetry-affiliated events, traces and conditions. Moreover, through a GUI, such as the GUI 167, a user may submit, to the central server 176, queries for network device deployment information (e.g., network telemetry information, configuration information as well as other information related to the network device deployment 118). In an example, the GUI 167 may be provided by specific client software that is executed on an administrative node 165 or, as another example, may be provided by an Internet browser that executes on the administrative node 165. In an example, the GUI 167 may allow a system administrator to manage various aspects of an NMS cluster 112. This management may include configuring network devices 114, providing configuration data (e.g., configuration files) to be transferred to network devices 114, initiating firmware upgrades on network devices 114, setting up base subscriptions for network telemetry reporting, as well as various other management-related actions.

In accordance with example implementations, when a network device 114 first connects to the network corresponding to the network device deployment 118, a dynamic host protocol configuration (DHCP) server may provide, to the network device 114, an Internet Protocol (IP) address of the activate server 160 (e.g., provide the IP address as a DHCP option). The activate server 160, among its other functions, validates the network device 114, and the activate server 160 provides, to the network device 114, upon successful validation, network artifacts (e.g., an IP address and credentials) for connecting to the central server 170.

A given network device deployment 118 may be migrated between NMS clusters 112. For the following example, it is assumed that a particular network device deployment 118 is migrated from the NMS cluster 112-2 (which may also be referred to as the “old NMS cluster 112-2” or “migrated NMS cluster 112-2”) to the NMS cluster 112-1 (which may also be referred to as the “new NMS cluster 112-1” or “target NMS cluster 112-1”). After the migration, old NMS cluster 112-2 retains data representing the previous (and now migrated) network device deployment 118. In an example, the data may represent network telemetry metric information about the network device deployment 118. In another example, the data may represent configuration data (e.g., network artifacts, certificates, configuration settings and/or configuration files) for the network device deployment 118. Instead of migrating all of the data from the old NMS cluster 112-2 to the new NMS cluster 112-1, in accordance with example implementations, most of the data is retained in database(s) 184 of the old NMS cluster 112-2. For a given period of time, called a “data retention period” herein, queries that are received by the new NMS cluster 112-1 may be served from data stored in either or both NMS clusters 112-1 and 112-2.

In accordance with example implementations, the NMS cluster 112 has a component of a federated query processing architecture, called the “federation layer engine 180.” The federation engine layer 180 of the new NMS cluster 112-1 intelligently directs a query that is received by the new NMS cluster 112-1 to either the new NMS cluster 112-1, the old NMS cluster 112-2 or both NMS clusters 112-1 and 112-2. The routing of the query by the federation layer engine 180 may be based on such factors as a query time, the migration date and whether the data retention period has ended. In this context, the “query time” refers to a particular time corresponding to the query. In an example, the query time may be a timestamp representing the time that the query is generated. In another example, the query time may be the time that the query is received by the federation layer engine 180.

Queries are discussed in examples herein, which request data. A given query, in accordance with further implementations, may serve other purposes, such as storing data in a database 184 of an NMS cluster 112 or modifying data stored in a database 184 of an NMS cluster 112.

In accordance with example implementations, the NMS cluster 112 includes a query processing layer 183, which includes a query layer engine 182. In accordance with example implementations, when a query is directed to the query processing layer 183 of the NMS cluster 112, the query layer engine 182 determines whether data corresponding to the query resides in the database(s) 184 of the NMS cluster 112. If so, the query layer engine 182 serves the query by providing a query result that includes the data.

Continuing the migration example, a query may be submitted to the new NMS cluster 112-1, which has a query time that is in one of three time periods: a first period before the migration date, a second period after the migration date while the data retention period is pending or a third period after the expiration of the data retention period. For a query having a query time within the data retention period, the query may be potentially served from either NMS cluster 112-1 or 112-2.

In accordance with example implementations, when the new NMS cluster 112-1 receives a query that has a query time corresponding to the second period (i.e., while the data retention period is pending), the federation layer engine 180 of the new NMS cluster 112-1 determines whether the query targets data before the migration date. If so, the federation layer engine 180 routes the query to the query processing layer 183 of the old NMS cluster 112-2. The query processing layer 183 of the old NMS cluster 112-2 may determine whether data corresponding to the data is stored in the old NMS cluster 112-2. If data corresponding to the data is not stored in the old NMS cluster 112-2, then the federation layer engine 180 redirects the query to the query processing layer 183 of the new NMS cluster 112-1.

In accordance with example implementations, when the new NMS cluster 112-1 receives a query that has a query time corresponding to the second period (i.e., while the data retention period is pending) and targets data after the migration date, then the federation layer engine 180 of the new NMS cluster 112-1 routes the query to the query processing layer 183 of the new NMS cluster 112-1. For queries that have respective query times after the end of the data retention period, the federation engine layer 180 of the new NMS cluster 112-1 routes the queries to the query processing layer 183 of the new NMS cluster 112-1.

In accordance with example implementations and as further described herein, the query layer engine 182 may provide one or multiple query processing optimizations. These optimizations may include a cache to store frequently accessed query data and machine learning-based predictive features to pre-populate the cache based on observed query usage patterns. The predictive features may include, as examples, predictive query execution and query enrichment.

In the context that is used herein, a “network telemetry metric” refers to information or content from which an insight to a state of a network, network device or client device connected network device(s) may be directly or indirectly determined. In an example, network telemetry data may include a periodically measured statistic of a network or network device metric, or measurement. In an example, a statistic may be a traffic flow volume (e.g., a traffic flow volume for a particular VLAN) for a particular sampling period. In other examples, a statistic may be a periodically measured egress bandwidth, an ingress bandwidth, a latency, a round trip time, or a usage of a resource or an activity of a host. In other examples, network telemetry data may represent a value of a counter of a network device, a configuration setting of a network device, an event log of a network device, a state snapshot of a network device, a configuration snapshot of a network device, or other information about a network device. Network telemetry data may represent events. In an example, a network device may send network telemetry messages, which are triggered by certain change events (e.g., a network telemetry message triggered by the sending of a disassociation message by the network device). In general, network telemetry data may represent information about the control, management and/or data planes of a network.

In the context that is used herein, a “network device” refers to an actual, or physical electronic component, which enables data communication between other components. In an example, a network device may be a switch that operates at level two (L2) of the Open Systems Interconnection (OSI) model to connect components of a computer network together. In another example, a network device may be a level three (L3) switch that connects both components of a computer network together and connects computer networks together. In other examples, a network device may be a gateway, a multicast router, a bridge, a component of a Gen-Z or a Compute Express Link (CXL) network, a processor device, a network interface controller (NIC) or a fabric switch that includes one or multiple of the foregoing devices. A network device may be a wired or wireless device.

In accordance with some implementations, a server, such as the activate server 160 or the central server 170, may correspond to machine-readable instructions (or “software”) that are executed on one or multiple nodes 188 of the central network management system 170. In the context that is used herein, a “node” refers to a processor-based entity that has an associated set of hardware and software resources. As depicted in FIG. 1, a node 188 may have one or multiple associated hardware processors 190 (e.g., one or multiple central processing unit (CPU) cores and/or one of multiple graphical processing unit (GPU) cores) and an associated memory 192. The memory 192 is a non-transitory storage media that may be formed from semiconductor storage devices, memristor-based storage devices, magnetic storage devices, phase change memory devices, a combination of devices of one or more of these storage technologies, and so forth. The memory 192 may represent a collection of memories of both volatile memory devices and non-volatile memory devices. In accordance with some implementations, the memory 192 may store machine-readable instructions that, when executed by one or multiple hardware processors 190 cause the hardware processor(s) 190 to form instances of components of the activate server 160 and the central server 170. In an example, the memory 192 may store machine-readable instructions that, when executed by one or multiple hardware processors 190 cause the hardware processor(s) 190 to form instances of the federation layer engine 180 and the query layer engine 182.

In an example, a node 188 may be an actual, or physical, entity, such as a computer platform or a part (e.g., a part corresponding to a group of CPU cores or CPU cores) of a computer platform. In this context, a “computer platform” is a processor-based electronic device, which has an associated operating system. In examples, a computer platform may be a rack server or blade server. In another example, a node 188 may be a virtual entity that is an abstraction of physical hardware and software resources, such as a virtual machine. Depending on the particular implementation, multiple nodes 188 may be located on one or multiple virtual or physical machines. Moreover, in accordance with example implementations, nodes 188 may be distributed across virtual or physical machines that are located at different geographical locations (e.g., located at different data centers).

As used here, an “engine” can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. An “engine” can refer to a combination of one or more hardware processing circuits and machine-readable instructions (software and/or firmware) executable on the one or more hardware processing circuits. In accordance with some implementations, one or multiple engines of the central server 170, such as the federation layer engine 180 or the query layer engine 182 may be formed by one or multiple processors 190 executing machine-readable instructions.

In accordance with some implementations, the central NMS components 171 may include multiple activate servers 160 and multiple central servers 170 for the same NMS cluster 112. In an example, for HA, a given service container for a particular NMS cluster 112 may contain an HA group of activate servers 160 and an HA group of central servers 170, so that should a given active server 160,170 fail, another server 160,170 may take over for the failed server 160,170 of the HA group.

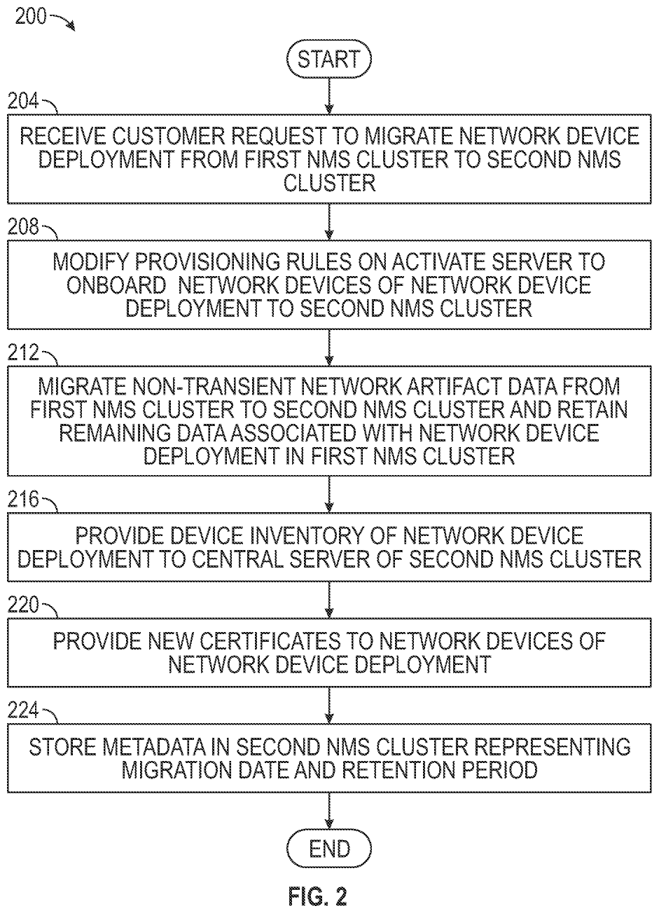

FIG. 2 depicts a process 200 for migrating a network device deployment from a first NMS cluster (the “old” or “migrated” NMS cluster) to a second NMS cluster (the “new” or “target” NMS cluster). Referring to FIG. 2, the process 200 includes receiving (block 204) a customer request to migrate a particular network device deployment from the first NMS cluster to the second NMS cluster. In an example, the customer may submit the request to a central server of the first NMS cluster. In another example, the customer may submit the request to a central server of the second NMS cluster.

Pursuant to block 208, the process 200 includes modifying provisioning rules on an activate server to onboard network devices of the network device deployment to the second NMS cluster. In an example, block 208 may include removing provisioning rules for the network devices from the first NMS cluster and creating provisioning rules for the network devices on the activate server of the second NMS cluster. In another example, a particular activate server may be shared by the first and second NMS clusters, and block 204 involves replacing a first set of provisioning rules (that specify how to provision the network devices on the first NMS cluster) on the active server with a second set of provisioning rules (that specify how to provision the network devices for the second NMS cluster). In accordance with example implementations, block 204 may include creating new provisioning rules for the network devices based on one or multiple internet protocol (IP) addresses and/or domain names associated with the network device deployment for the second NMS cluster.

In accordance with example implementations, the process 200 includes migrating non-transient network artifact data from the first NMS cluster to the second NMS cluster, while retaining the remaining data that is associated with the network device deployment in the first NMS cluster. In accordance with example implementations, block 212 is a first step in an NMS mode change from the network device deployment being in the first NMS cluster to being in the second NMS cluster. In an example, the non-transient data may include data representing tags, scopes, configurations, floorplans, user input data or other non-transient data.

The next part of the NMS mode change includes, in accordance with example implementations, providing (block 216) the network device inventory of the network device deployment to the central server of the second NMS cluster. In an example, in accordance with some implementations, the transfer of the network device inventory does not involve inventory reconciliation, as the network device inventory remains unchanged.

In accordance with example implementations, the next part of the NMS mode change includes, pursuant to block 220, providing new digital certificates to the network devices of the network device deployment. In an example, the network devices may receive the new digital certificates from a certificate certification service (CCS), and the second NMS cluster trusts the digital certificates that are presented by a root certificate authority (and published by the activate server).

In accordance with example implementations, the fourth part of the NMS mode change includes, pursuant to block 224, storing metadata in the second NMS cluster representing a migration date and a data retention period. In an example, block 224 may include updating the activate server of the second NMS cluster with a provisioning rule that points to the second NMS cluster for all network devices that are being migrated. Near or at the end of the migration of the non-transient network artifact data (block 212), in accordance with example implementations, the central server of the first NMS cluster may disconnect the network devices and reject new attempted connections by these devices. In an example, a particular network device may be configured to contact the activate server after a predetermined number (e.g., three) of connection failures. The activate server, in turn, provides the new provisioning rule to the network device for connecting to the second NMS cluster.

The migration data, in accordance with example implementations, defines the data retention policy for one or multiple network device deployments. The metadata controls how a federation layer engine (e.g., the federation layer engine 180 of FIG. 1) of a particular NMS cluster routes queries that are directed to the NMS cluster. In an example, a particular NMS cluster may store the following metadata:

| | | Retention | |
|---|---|---|---|
| | Migration | Period in | Old Cluster |
| Customer ID | Date | Days | URI |
| 220d0d3b-e480-400b- | 1 Jun. 2022 | 90 | old1-central- |
| 9948-0ef669030f63 | | | cluster.com |
| 05429a46-30f5-4558- | 2 Jun. 2022 | 60 | old2-central- |
| bd3b-bebb6711832b | | | cluster.com |

For this example, the metadata stores retention data for two network device deployments that were migrated to the NMS cluster. For a particular customer (corresponding to the second row above), the metadata sets forth a migration date of Jun. 1, 2022, a retention period of ninety days and a uniform resource identifier (URI (e.g., a Uniform Resource Locator (URL)) of the old NMS cluster. Moreover, for this example, the migration data sets forth migration information for a second customer (corresponding to the third row above) for a migration date of Jun. 2, 2022, a retention period of sixty days and a URI of the old NMS cluster.

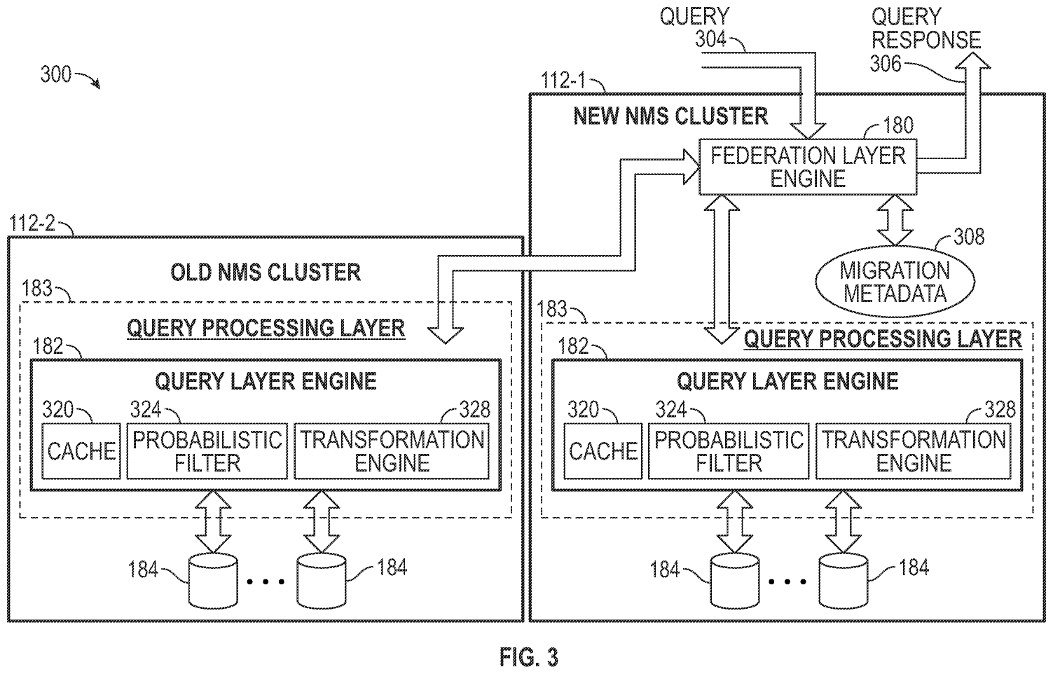

FIG. 3 depicts a federated query processing architecture 300 in accordance with example implementations. For this example, a network device deployment has been migrated from a migrated, or old, NMS cluster 112-2 to a target, or new, NMS cluster 112-1. Moreover, for this example, the new NMS cluster 112-1 receives a query 304. Based on a query time that is associated with the query 304, the federation layer engine 180 of the new NMS cluster 112-1 routes, or directs, the query 304 (as illustrated by path 302) to either a query layer processing layer 183 of the old NMS cluster 112-2 or (as illustrated by path 303) a query processing layer 183 of the new NMS cluster 112-1. The federation layer engine 180, in accordance with example implementations, performs the routing of the query 304 based on a query time associated with the query 304 and a query processing policy that is defined by migration metadata 308.

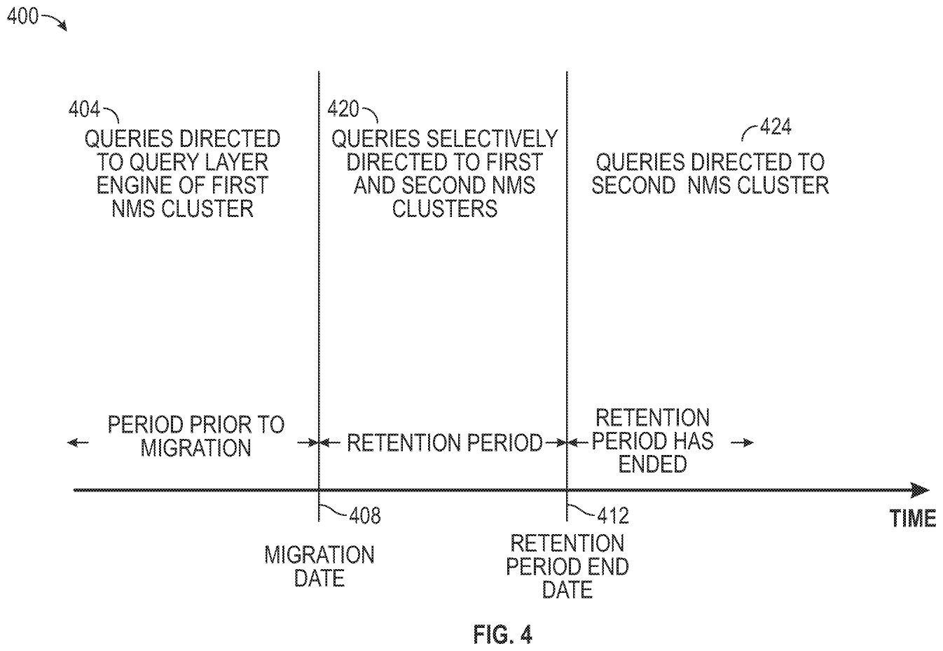

Referring also to FIG. 4 in conjunction with FIG. 3, the migration metadata 308, in accordance with example implementations, defines a migration date 408 and a data retention period end date 412. In an example, the migration date 408 may be a calendar date corresponding to the day that the migration occurred. In an example, the data retention period end date 412 may correspond to a calendar date that a retention period that is specified by the migration metadata 308 ends. As depicted at 404, the federation layer engine 180 directs queries that have respective queries times prior to the migration date 408 to the old NMS cluster 112-2. For queries that have respective query times that correspond to a pending retention period (e.g., after the migration date 408 and on or before the data retention period end date 412), as depicted at 420, the federation layer engine 180 selectively directs the corresponding queries to the old 112-2 and new NMS 112-1 clusters. As further described herein, the federation layer engine 180 may base the selective directing, or routing, of the queries on the data being queries (e.g., whether data before or after the migration date 208 is being queries). As depicted at 424, the federation layer engine 180 directs queries that have respective query times after the data retention period end date 412 to the query processing layer 183 of the new NMS cluster 112-2.

In accordance with example implementations, the query layer engine 182 has features to optimize the query processing. In accordance with example implementations, the query layer engine 182 may, before migration, create time indices for tables stored in the databases 184, which already do not have time indices. If a query time corresponds to a particular time index for a table, then the table is selected to serve the query. In accordance with example implementations, the query layer engine 182 may create secondary indices for tables stored in the databases 184. Secondary indices aid in improving selectivity and expediting query processing time. For example, a secondary index using a customer ID may improve query processing time, because most of the queries may be based on time and customer IDs.

In accordance with example implementations, the query layer engine 182 may have a probabilistic filter 324. The query layer engine 182, in accordance with example implementations may test the probabilistic filter 324 for a key that corresponds to the query 304 for purposes of determining whether data corresponding to key is present in the database(s) 184. The query layer engine 182, in accordance with example implementations, may also update the probabilistic filter 324 as data is stored and/or retrieved in the database(s) so that the probabilistic filter 324.

In an example, the probabilistic filter 324 may be a Bloom filter. A Bloom filter includes a bit array that may be evaluated for purposes of evaluating, or testing, whether an element is a member of a set. When used as the probabilistic filter 324, a Bloom filter may be used to evaluate whether the data requested by a query 304 is present in the database(s) 184 of the NMS cluster. More specifically, a Bloom filter may be associated with a set of hash functions that produce respective hashes of an input value. Each hash, in turn, identifies a particular position of the bit array. The testing of the Bloom filter reveals a high likelihood that an input value is stored in the database(s) 184 if the bits stored in the bit array positions that are identified by the hashes are all Boolean TRUE values (e.g., “1” bits). The testing of the Bloom filter may be used to deterministically rule out that the input value is stored in the database(s) 184 if any of the bits stored in the bit array positions that are identified by the hashes is a Boolean FALSE value (e.g., a “0” bit). The Bloom filter may be updated when the database(s) are queried for a particular input value by hashing the key with the set of hash functions to identify bit array positions of the bit array, and setting bits at the bit array positions to the appropriate Boolean value based on whether the data store contains the input value.

In an example, input values that are used to test and update the Bloom filter may be associated with one or multiple database index keys. In an example, an input value may correspond to a customer ID index key. In another example, an input value may correspond to a network device serial number index key. In another example, an input value may correspond to a media access control (MAC) address key. In another example, an input value may correspond to an application ID index key. In an example, a given query 304 may specify values corresponding to one or multiple database index keys (e.g., one or multiple of a customer ID index key, a network device serial number index key, a MAC address index key and an application ID index key), and the query processing engine 182 may test the Bloom filter with the values for purposes of determining whether the database(s) 184 store the values.

Moreover, the query processing engine 182 may update the Bloom filter. In an example, the Bloom filter may indicate a false positive result for a particular index value, as revealed by the further processing of the query 304 by the query processing engine 182, and the query processing engine 182 may update the Bloom filter to reflect that the index value is not stored in the database(s) 184. In another example, the query processing engine 182 may update the Bloom filter when a particular index value is stored in the database(s) 184.

In accordance with some implementations, an NMS cluster may have multiple probabilistic filters 324, such as, for example, a probabilistic filter 342 for each database 184. In other examples, an NMS cluster may have multiple probabilistic filters 342 for different database index keys or different index key combinations.

Among the particular features of the Bloom filter, the bit array may have a bit size (e.g., a size on the order of kilobytes) that is optimized to minimize false positive results. The query processing engine 182 may update the Bloom filter based on query results withing a particular sliding time window to impart a particular time granularity (e.g., a granularity of several hours) to the Bloom filter, depending on the particular use case of queries to the database(s) 184. In an example, three hash functions may be used to provide hashes to evaluate the bit array.

In the context that is used herein, a “hash” (which may also be referred to as a “hash,” “hash value,” “hash digest,” “cryptographic hash,” or “cryptographic hash value”) is produced by the application of a cryptographic hash function to a value. A cryptographic hash function may receive an input, and the cryptographic hash function may then generate a hexadecimal string to match the input. For example, the input may include a string of data (for example, the data structure in memory denoted by a starting memory address and an ending memory address). In such an example, based on the string of data the cryptographic hash function outputs a hexadecimal string. Further, any minute change to the input may alter the output hexadecimal string. In another example, the cryptographic hash function may be a secure hash function (SHA), any federal information processing standards (FIPS) approved hash function, any national institute of standards and technology (NIST) approved hash function, or any other cryptographic hash function. In some examples, instead of a hexadecimal format, another format may be used for the string.

In accordance with further examples, the probabilistic filter 324 may be a filter other than a Bloom filter, such as a cuckoo filter or another probabilistic data structure.

As depicted in FIG. 3, in accordance with some implementations, the query layer engine 182 may include a cache 320 to improve query processing performance. In this manner, data that corresponds to a query 304 and is stored in the cache 320 may be retrieved faster, as compared to retrieving the data from a database 304. Any of a number of different polices may be used to manage the storage of data in the cache 320 and the eviction of data from the cache 320. In an example, the query layer engine 320 may learn a query usage pattern over a certain period of time and pre-populate data into the cache 320 to serve future queries based on the learned query usage pattern. In an example, queries that target application visibility (e.g., queries that target insights about applications, such as a query that targets the health, performance or security of an application) or client visibility (e.g., queries that target insights about client devices, such as a query that targets the health, performance or security of a client device) may be performance intensive and at the same time follow a predictable pattern of usage.

In an example, the query layer engine 182 may observe one or multiple query usage patterns for a particular customer ID over a predetermined period of time (e.g., the last two weeks). In an example, the query layer engine 182 may observe a pattern of queries for a certain customer ID that target a particular application ID, certain network devices, and certain network telemetry metrics. Continuing the example, the query layer engine 182 may pre-run (e.g., generate and process) queries that 1. target the application ID, network devices and network telemetry metrics and 2. are consistent with the observed pattern. These queries populate the cache 320 with data that is expected to be requested by queries 304 in the near future.

In accordance some implementations, the query layer engine 182 may train and use a machine learning model 327 to learn query usage patterns and based on the learned query usage patterns predict one or multiple future queries. In accordance with some implementations, the model 327 a deep learning, recurrent neural network (RNN) model that learns dependencies from an observed sequence, such as a Long Short Term Memory (LSTM) model to predict the time difference in the next query. The LSTM model constructs a time series of queries, with the prediction is based on the past sequences of the query period against the time difference. In an example, the LSTM model may be constructed by converting query periods by one hot encoding based on the following query period categories: monitoring (e.g., query periods of three hours, one day, one week, one month and three months), unified critical communications (UCC) (e.g., query periods of three hours, one day, one week and one month) and client monitoring (e.g., query periods of three hours, one day, one week, one month and three months) Any of a number of features related to past queries may be used to extend the LSTM model, such as customer queries, customer profile clustering, deployment use cases, location, NMS characteristics, intent of deployment, speculative client count, pattern of traffic, pattern of queries, network device types, number of network node, customized parameters customized, security hardening parameters, network classifications, network tagging, as well as other and/or different features.

Some queries 304 may be for pre-determined periods, such as one day, one week, and so forth, and queries 304 from new users may overlap, in time, queries that have been previously processed and have corresponding data stored in the cache 320. Therefore, for a given query 304 that targets a predetermined period, the cache 320 may store part of the data requested by the given query 304. In accordance with example implementations, responsive to such a query, the query layer engine 182 partially relies on the cached data, and the query layer engine 182 generates and processes one multiple delta queries to retrieve the data from the database(s) 184 corresponding to the data for the predetermined period, which is not stored in the cache 320.

In accordance with example implementations, the query layer engine 182 may modify, or enrich, a query 304 based on whether some of the data that satisfies the query 304 is stored in the cache 320. In an example, if the query layer engine 182 determines that a subset of data targeted by a given query 304 is stored in the cache 320, the query layer engine 182 enriches the given query 304 to target all or part of the targeted data, which is not stored in the cache 320.

In accordance with example implementations, the query layer engine 192 may enrich a particular query 304 based on a future query prediction (e.g., a prediction of one or multiple future queries by the model 327). Therefore, in lieu of, for example, pre-running a query to prepopulate the cache 320, the query layer engine 192 may, for example, enrich a received query 304 to cover an anticipated future query and prepopulate the cache 320 with data targeted by the anticipated future query.

In accordance with example implementations, the query layer engine 182 includes a transformation engine 328. The transformation engine 328, in accordance with example implementations, performs aggregation functions to satisfy particular use cases. In an example, the transformation engine 328 may perform an aggregation responsive to the query 304, such as a summation, average, maximum or minimum. In accordance with some implementations, the transformation engine 328 may perform an approximated “top N” aggregation across multiple NMS clusters. In accordance with example implementations, the transformation engine 328 may return unique counts across the NMS cluster, and the federation layer engine may combine unique counts across multiple clusters to provide a unique count per entity (e.g., a MAC address or application ID). In accordance with some implementations, to enable the display of accurate state information across the cluster, query layer engine 182 passes the state information along with a timestamp back as information to the federation layer engine 182 so that the federation layer engine 182 is able to identify and consider the latest state information.

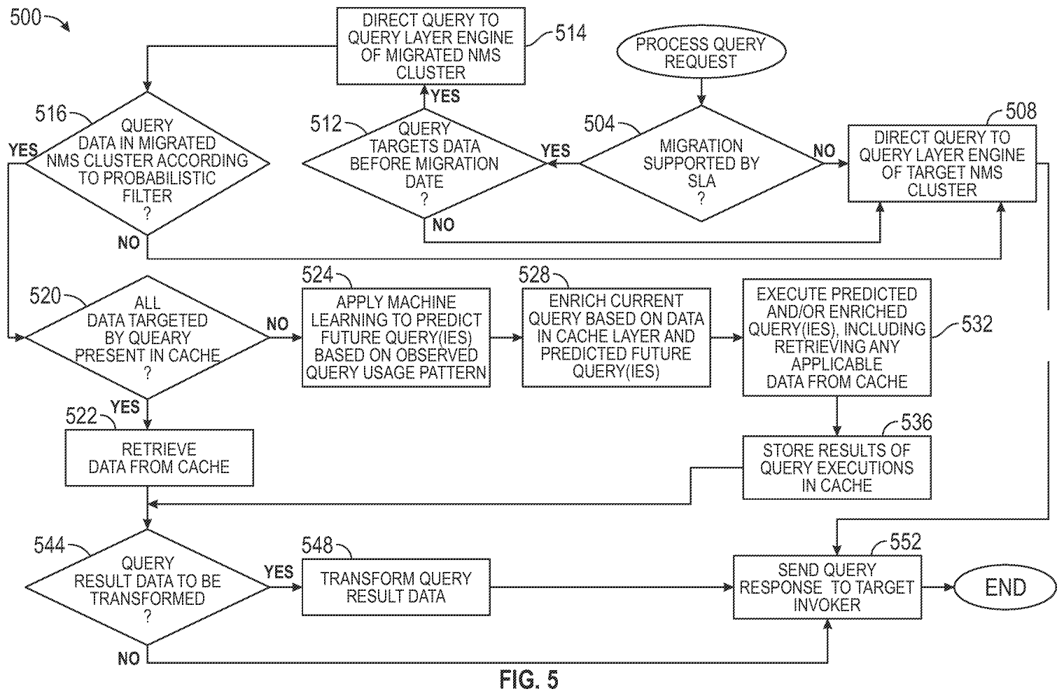

FIG. 5 depicts an example process 500 for processing a query that is received in a target NMS cluster in accordance with example implementations. For this example, a network device deployment has been migrated from the previous, or old (or “migrated”) NMS cluster to the target NMS cluster.

Referring to FIG. 5, the process 500 first includes decisions that may be made by a federation layer engine of the target NMS cluster. The decision includes determining (decision block 504) whether migration is supported by a service level agreement (SLA). In this manner, whether the migration is supported by the SLA, in this context, refers to the SLA specifying details about the migration, such as, for example, a number of calendar days for a data retention period. If the SLA does not support migration, then the process 500 includes the federation layer engine directing the query to be processed by the query processing layer of the target NMS cluster, pursuant to block 508.

If, according to decision block 504, migration is supported by the SLA, then the federation layer engine performs a further determination, pursuant to decision block 512, whether the query targets data before the migration date. Stated differently, in decision block 512, the process 500 includes determining whether the query time is within the data retention period (i.e., whether the data retention period is still pending). If the query targets data before the migration date, then the federation layer engine directs the query to the query processing layer of the target NMS cluster, pursuant to block 508. If, however, pursuant to decision block 512, the federation layer engine determines that the query time is before the migration date, then the federation layer engine first directs the query to the query layer engine of the migrated NMS cluster, as depicted at block 514.

The process 500 next depicts actions that may be taken by the query processing layer of the migrated NMS cluster. In accordance with example implementations, the query processing layer of the migrated NMS cluster may determine, pursuant to decision block 516, whether data corresponding to the query is stored in the migrated NMS cluster by testing a probabilistic filter. If the testing of the probabilistic filter reveals that the query data is not present in the migrated NMS cluster, then the query is redirected back to the query processing layer of the target NMS cluster, per block 508. In accordance with example implementations, the redirection of the query back to the target NMS cluster may, for example, involve the query processing layer of the migrated NMS cluster indicating to the federation layer engine of the target NMS cluster that the query processing layer of the migrated NMS cluster cannot serve the query, and in response to this indication, the federation layer engine redirects the query to the query processing layer of the target NMS cluster.

In accordance with example implementations, if, pursuant to decision block 516, the testing of the probabilistic filter reveals that data corresponding to the query is present in the migrated NMS cluster, then processing of the query by the query processing layer of the migrated NMS cluster continues. More specifically, in accordance with example implementations, the query processing layer of the migrated NMS cluster may then determine (decision block 520) whether data corresponding to the query is present in a cache of the query processing layer. If so, then the data is retrieved from the cache layer, pursuant to block 522. If, however, the query data is not present in the cache, as determined by decision block 520, then, in accordance with example implementations, the query processing layer may apply one or multiple optimizations. For example, as depicted in FIG. 5, these optimizations may include applying (block 524) machine learning to predict one or multiple future queries based on one or multiple observed query patterns. Based on the predicted future query (ies), then, pursuant to block 528, the current query may be enriched based on data in the cache layer and the predicted future query (ies) to execute predicted queries, as depicted in block 532. The query processing layer of the migrated NMS cluster may then store results of the predicted query execution(s) in the cache, pursuant to block 536. If all data corresponding to the query is present in the cache, as determined at decision block 520, then, in accordance with example implementations, the query processing layer of the migrated NMS cluster retrieves the data from the cache, pursuant to block 522.

Regardless of whether the data is retrieved from the cache (block 522) or retrieved by the enriched query (ies), the process 500 includes determining, in decision block 544, whether the query result data is to be transformed. If so, then, pursuant to block 548, the query result data is transformed. The process 500 further includes sending (block 552) the query response to the target invoker.

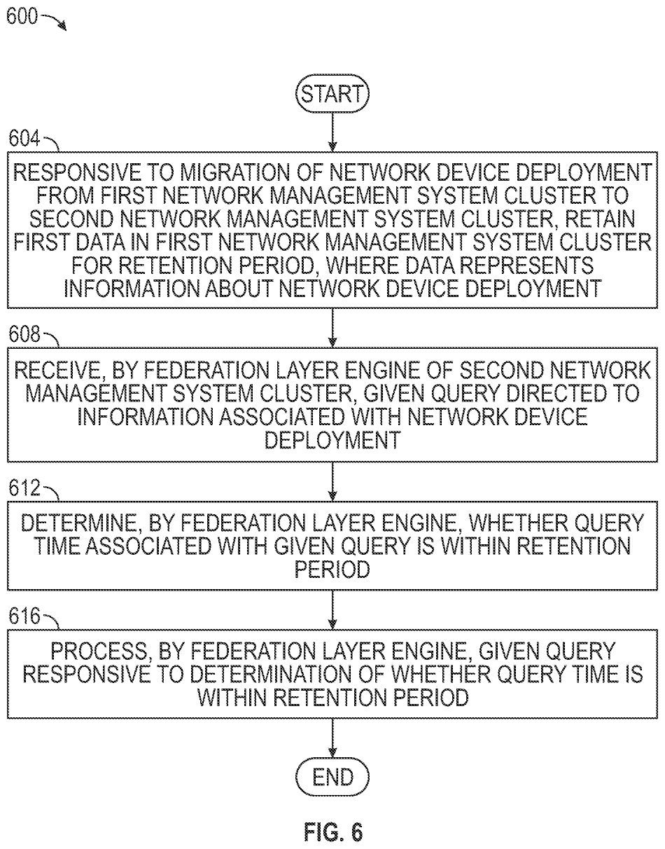

Referring to FIG. 6, in accordance with example implementations, a process 600 includes, pursuant to block 604, responsive to a migration of a network device deployment from a first network management system cluster to a second network management system cluster, retaining first data in the first network management system cluster for a retention period. The data represents information about the network device deployment. In an example, a network device deployment may be migrated to a geographical region that is the same as geographical region of central components of the second network management system. In an example, non-transient network artifact data for network devices of the network device deployment may be migrated to the second network management system cluster. In an example, data representing network telemetry metric information for the network device deployment may be retained in one or multiple databases of the first network management system cluster and is not transferred to the second network management system cluster. In an example, the second network management cluster may include cloud-based central components, such as a central server and an activate server.

The process 600 further includes, pursuant to block 608, receiving, by a federation layer engine of the second network management system cluster, a given query directed to information associated with the network device deployment. Pursuant to block 612, the process 600 includes determining, by the federation layer engine, whether a query time that is associated with the given query is within the retention period. In an example, the query time is the time at which the given query is generated. In an example, the federation layer engine may correspond to machine-readable instructions that are executed by one or multiple hardware processors. In an example, the federation layer engine may determine whether the query time is within the retention period based on metadata. In an example, the metadata may represent a customer ID associated with the network device deployment, a calendar date corresponding to a migration date and a number of days corresponding to the retention period.

The process 600 includes, pursuant to block 616, processing, by the federation layer engine, the given query responsive to the determination of whether the query time is within the retention period. In an example, the federation layer engine may direct the query to a query layer engine of the first network management cluster responsive to the federation layer engine determining that the query time is within the retention period and the given query targets data prior to the migration date. In an example, the federation layer engine may direct the query to a query layer engine of the second network management cluster responsive to the federation layer engine determining that the given query targets data after the migration date.

In an example, a query layer engine may determine, based on a predictive filter, whether data targeted by the given cluster is stored in the network management system cluster based on a probabilistic filter. In an example, the probabilistic filter may be a Bloom filter. In an example, a query layer engine may retrieve data targeted by the given query from a cache. In an example, a query layer engine may use a machine learning model to learn a query usage pattern and based on the query usage pattern, predict future queries. In an example, a query layer engine may pre-run predicted future queries to pre-populate the cache. In an example, a query layer engine may enrich received queries based on predicted queries to pre-populate the cache. In an example, a query layer engine may responsive to a query that spans a particular time period, serve the query with data from the cache and by generating and processing one or multiple delta queries to retrieve the remaining data. In an example, the query layer engine may correspond to machine-readable instructions that are executed by one or multiple hardware processors.

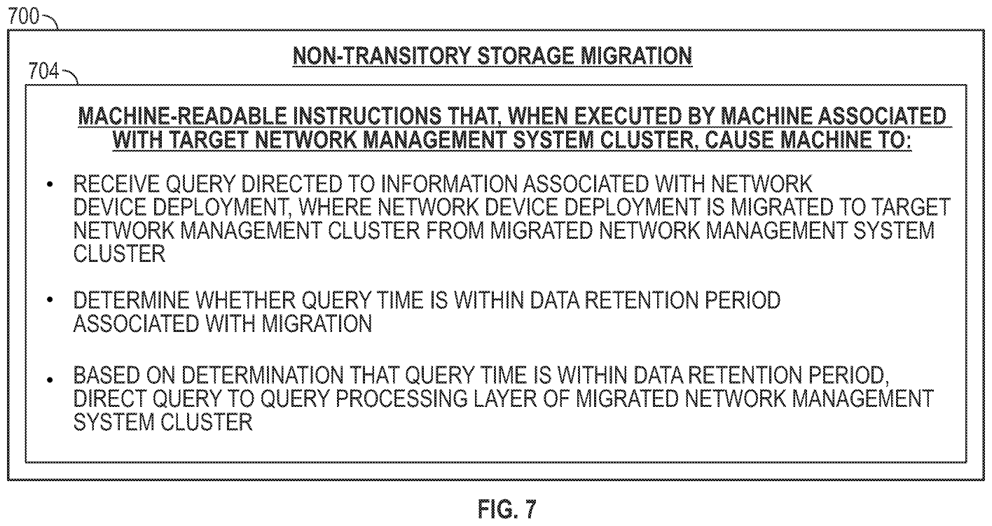

Referring to FIG. 7, in accordance with example implementations, a non-transitory storage medium 700 stores machine-readable instructions 704. The instructions 704, when executed by a machine associated with a target network management system cluster, cause the machine to receive a query that is directed to information that is associated with a network device deployment. The network device deployment is migrated to the target network management system cluster from a migrated network management system cluster. In an example, a network device deployment may be migrated to a geographical region that is the same as geographical region of central components of the second network management system. In an example, non-transient network artifact data for network devices of the network device deployment may be migrated to the target network management system cluster. In an example, data representing network telemetry metric information for the network device deployment may be retained in one or multiple databases of the migrated network management system cluster and is not transferred to the target network management system cluster. In an example, the migrated and target network management system clusters may each include cloud-based central components, such as a central server and an activate server.

The instructions 704, when executed by the machine, cause the machine to determine whether a query time is within a data retention period associated with the migration. In an example, the query time is the time at which the given query is generated. In an example, the instructions, when executed by the machine, may cause the machine to determine whether the query time is within the retention period based on metadata that is stored in the target network management system cluster. In an example, the metadata may represent a customer ID associated with the network device deployment, a calendar date corresponding to a migration date and a number of days corresponding to the retention period.

The instructions 704, when executed by the machine, cause the machine to, based on the determination that the query time is within the data retention period, direct the query to a query processing layer of the migrated network system management cluster. In an example, the instructions 704, when executed by the machine, cause the machine to route the query to a query processing layer of the target network management system cluster responsive to the migrated network management system cluster determining that the migrated network management system cluster does not contain data corresponding to the query.

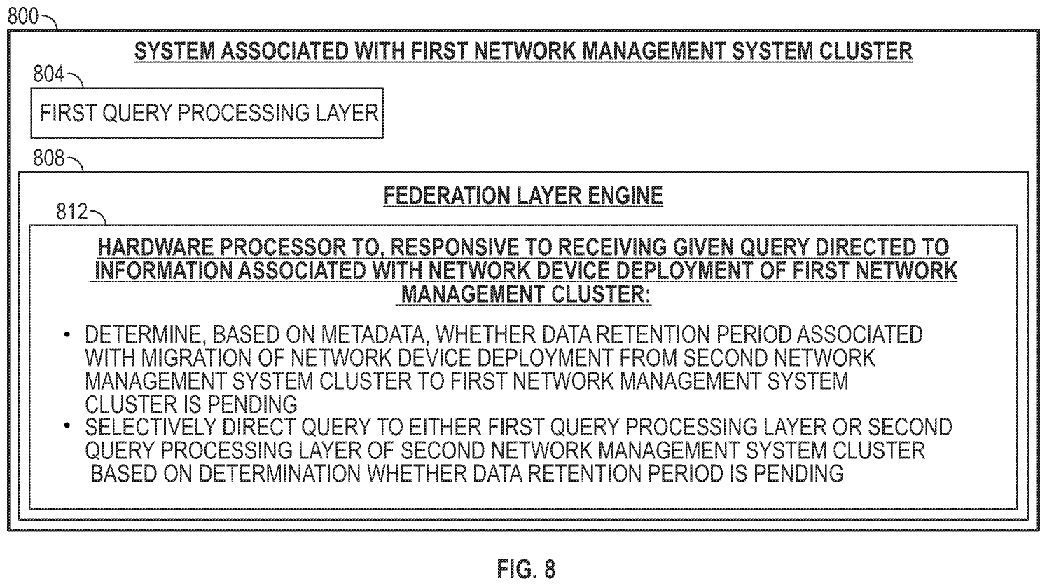

Referring to FIG. 8, in accordance with example implementations, a system that is associated with a first network management system cluster 800 includes a first query processing layer 804 and a federation layer engine 808. The federation layer engine 808 includes a hardware processor 812. The hardware processor 812, responsive to receiving a given query that is directed to information that is associated with a network device deployment of the first network management cluster, determines, based on metadata, whether a data retention period associated with a migration of the network device deployment from a second network management system cluster to the first network management system cluster is pending. In an example, the first query processing layer 804 may correspond to machine-readable instructions that are executed by one or multiple hardware processors.

In an example, the network device deployment may be migrated to a geographical region that is the same as geographical region of central components of the first network management system cluster. In an example, non-transient network artifact data for network devices of the network device deployment may be migrated to the first network management system cluster. In an example, data representing network telemetry metric information for the network device deployment may be retained in one or multiple databases of the second network management system cluster and is not transferred to the first network management system cluster. In an example, the first network management cluster may include cloud-based central components, such as a central server and an activate server.

In an example, the metadata may represent a customer ID associated with the network device deployment. In an example, the metadata may represent a calendar date that corresponds to the migration date at which the second network management system cluster was migrated to the first network management system cluster. In an example, the metadata may represent a number of days corresponding to the data retention period.

The hardware processor 812, responsive to receiving the given query, selectively directs the query to either the first query processing layer 804 or a second query processing layer of the second network management system cluster based on the determination of whether the data retention period is pending. In an example, the first query processing layer 804 may retrieve data corresponding to the given query from a cache. In an example, the first query processing layer 804 may use a machine learning model to learn a query usage pattern and based on the query usage pattern, predict future queries. In an example, the first query processing layer 804 may pre-run predicted future queries to pre-populate the cache. In an example, the first query processing layer 804 may enrich received queries based on predicted queries to pre-populate the cache. In an example, the first query processing layer 804 may, responsive to the given query spanning a particular time period, serve the given query with data from the cache and data provided by processing one or multiple delta queries.

In accordance with example implementations, the processing includes, responsive to determining that the query time is within the retention period, determining whether the query targets data that is associated with a time before the migration; and responsive to determining that the given query targets data associated with a time before the migration, determining whether data stored in the first network management system cluster satisfies the given query. The process further includes, responsive to determining that the query time is within the retention period and based on a result of the determination of whether data that is stored in the first network management system cluster, satisfies the query, directs the given query to a query process layer of the second network management system cluster. A particular advantage is that time and costs associated with migrating a network device deployment to another network management system cluster are reduced.

In accordance with example implementations, determining whether data stored in the first network management system cluster satisfies the given query includes determining, based on a probabilistic filter, that the data is stored in the first network management system cluster. A particular advantage is that time and costs associated with migrating a network device deployment to another network management system cluster are reduced.

In accordance with example implementations, determining that the data is stored in the first network management system cluster includes determining a plurality of hashes based on at least one of a customer identification, a network device serial number, a media access control (MAC) address and an application identification. Determining that the data is stored in the first network management system cluster further includes providing the plurality of hashes to the probabilistic filter to test the filter for the data. A particular advantage is that time and costs associated with migrating a network device deployment to another network management system cluster are reduced.

In accordance with example implementations, a determination is made whether a cache of the first network management system cluster stores the data corresponding to the query. A particular advantage is that time and costs associated with migrating a network device deployment to another network management system cluster are reduced.

In accordance with example implementations, machine learning is applied to learn a query usage pattern; and based on the query usage pattern, queries are executed according to the query usage pattern to pre-populate the cache with data that corresponds to the query results. A particular advantage is that time and costs associated with migrating a network device deployment to another network management system cluster are reduced.

In accordance with example implementations, responsive to the given query, a second query is predicted; and the second query is processed, which includes adding result data for the second query to the cache. A particular advantage is that time and costs associated with migrating a network device deployment to another network management system cluster are reduced.

In accordance with example implementations, responsive to the given query, a second query is predicted, the given query is enriched based on the prediction to provide a third query, and the third query is processed. The processing of the third query includes adding result data for the third query to the cache. A particular advantage is that time and costs associated with migrating a network device deployment to another network management system cluster are reduced.

In accordance with example implementations, the process includes, responsive to determining that the query time is within the retention period, determining whether the given query targets data that is associated with a time after the migration. The given query is directed to a query processing layer of the second network management system cluster responsive to determining that the given query targets data that is associated with a time after the migration. A particular advantage is that time and costs associated with migrating a network device deployment to another network management system cluster are reduced.

In accordance with example implementations, responsive to determining that the query time is outside of the retention period, the given query is directed to a query processing layer of the second network management system cluster. A particular advantage is that time and costs associated with migrating a network device deployment to another network management system cluster are reduced.

In accordance with example implementations, data corresponding to the given query is retrieved, and responsive to the given query, an aggregation function is applied to the retrieved data to drive a query result. A particular advantage is that time and costs associated with migrating a network device deployment to another network management system cluster are reduced.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
responsive to a migration of a network device deployment from a first network management system cluster to a second network management system cluster, retaining first data in the first network management system cluster for a retention period, wherein the data represents information about the network device deployment;
receiving, by a federation layer engine of the second network management system cluster, a given query directed to information associated with the network device deployment;
determining, by the federation layer engine, whether a query time associated with the given query is within the retention period; and
processing, by the federation layer engine, the given query responsive to the determination of whether the query time is within the retention period.

2. The method of claim 1, wherein the processing comprises, responsive to determining that the query time is within the retention period:
determining whether the given query targets data associated with a time before the migration;
responsive to determining that the given query targets data associated with a time before the migration, determining whether data stored in the first network management system cluster satisfies the given query; and
based on a result of the determination of whether data stored in the first network management system cluster satisfies the query, directing the given query to a query processing layer of the second network management system cluster.

3. The method of claim 2, wherein determining whether data stored in the first network management system cluster satisfies the given query comprises determining, based on a probabilistic filter, that the data is stored in the first network management system cluster.

4. The method of claim 3, wherein determining that the data is stored in the first network management system cluster comprises:
determining a plurality of hashes based on at least one of a customer identification, a network device serial number, a media access control (MAC) address and an application identification; and
providing the plurality of hashes to the probabilistic filter to test the probabilistic filter for the data.

5. The method of claim 2, further comprising:
determining whether a cache of the first network management system cluster stores the data corresponding to the query.

6. The method of claim 5, further comprising:
applying machine learning to learn a query usage pattern;
based on the query usage pattern, executing queries according to the query usage pattern to pre-populate the cache with data corresponding to query results.

7. The method of claim 5, further comprising, responsive to the given query:
predicting a second query; and
processing the second query, including adding result data for the second query to the cache.

8. The method of claim 5, further comprising, responsive to the given query:
predicting a second query;
enriching the given query based on the prediction to provide a third query;
processing the third query, including adding result data for the third query to the cache.

9. The method of claim 1, wherein the processing comprises, responsive to determining that the query time is within the retention period:
determining whether the given query targets data associated with a time after the migration; and
responsive to determining that the given query targets data associated with a time after the migration, directing the given query to a query processing layer of the second network management system cluster.

10. The method of claim 1, further comprising:
responsive to determining the query time is outside of the retention period, directing the given query to a query processing layer of the second network management system cluster.

11. The method of claim 1, further comprising:
retrieving data corresponding to the given query; and
responsive to the given query, applying an aggregation function to the retrieved data to derive a query result.

12. A non-transitory storage medium to store machine-readable instructions that, when executed by a machine associated with a target network management system cluster, cause the machine to:
receive a query directed to information associated with a network device deployment, wherein the network device deployment being migrated to the target network management system cluster from a migrated network management system cluster;
determine whether the query time is within a data retention period associated with the migration; and
based on the determination that the query time is within the data retention period, direct the query to a query processing layer of the migrated network system management cluster.

13. The storage medium of claim 12, wherein the instructions, when executed by the machine, further cause the machine to responsive to a redirection of the query by the migrated network system management cluster, direct the query to a query processing layer of the target network management system cluster.

14. The storage medium of claim 13, wherein the instructions, when executed by the machine, further cause the machine to, responsive to the query being directed to the query processing layer of the target network management system cluster, test a probabilistic filter to determine if the target network management system cluster stores data corresponding to the query.

15. The storage medium of claim 13, wherein the instructions, when executed by the machine, further cause the machine to, responsive to the query being directed to the query processing layer of the target network management system cluster, determine whether data corresponding to the query is stored in a cache of the query processing layer of the target network management system cluster.

16. The method of claim 15, wherein the instructions, when executed by the machine, further cause the machine to, responsive to the query being directed to the query processing layer of the target network management system cluster:
apply machine learning to learn a query usage pattern;
based on the query usage pattern, execute queries according to the query usage pattern to pre-populate the cache with data corresponding to query results.

17. A system associated with a first network management system cluster, wherein the system comprises:
a first query processing layer; and
a federation layer engine comprising a hardware processor to, responsive to receiving a given query directed to information associated with a network device deployment of the first network management cluster:
determine, based on metadata, whether a data retention period associated with a migration of the network device deployment from a second network management system cluster to the first network management system cluster is pending; and
selectively direct the query to either the first query processing layer or a second query processing layer of the second network management system cluster based on the determination of whether the data retention period is pending.

18. The system of claim 12, wherein the hardware processor to further:
determine that the data retention period is pending;
direct the query to the second network management system responsive to determining that the data retention period is pending; and
process the query responsive to the second network management system cluster determining that the second network management system cluster does not store data corresponding the query.

19. The system of claim 18, wherein the query comprises a first query, and the hardware processor to further:
retrieve first data stored in the first network management system cluster corresponding to the first query;
apply machine learning based on an observed query usage pattern to predict a second query;
process the second query to provide second data;
combine the first data and the second data to provide a query response to the first query.

20. The system of claim 18, wherein the query comprises a first query, and the hardware processor to further:
apply machine learning based on an observed query usage pattern to predict a second query;
enrich the first query based on the second query to provide an enriched first query; and
process the enriched first query to provide a query response to the first query and provide data not corresponding to the first query to pre-populate a cache of the first network management system cluster.
